(19) United States
(12) Patent Application Publication
(10) Pub. No.: US 2005/0053062 A1
(43) Pub. Date: Mar. 10, 2005

(54) Adapting the data rate and/or the amount of data of content to be transmitted separately for at least two radio access networks e.g. umts, geran

(76) Inventors: Jan Kall, Espoo (FI); Ahri Muhonen, Hirvihaara (FI); Jens Staack, Ojakkala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/493,904

(22) PCT Filed: Oct. 29, 2001
(86) PCT No.: PCT/EP01/12488

(51) Int. Cl. H04L 12/56

(52) U.S. Cl. 370/389

(57) ABSTRACT

The invention relates to a method for providing packet delivery and/or forwarding services via at least one PLMN, wherein a packet handling unit (1) receives from a content source (2, 3) content for a respective service that is to be transmitted via at least two different kinds of radio access networks (4, 5) of said at least one PLMN. In order to enable such a transmission, it is proposed that the packet handling unit (1) adapts the content data rate and/or the amount of data of the content separately for each radio access network (4, 5) via which the content is to be transmitted. The packet handling unit 1 then forwards the content to each of these radio access networks (4, 5) with the respective adapted data rate and/or the respective adapted amount of data. The invention equally relates to a corresponding packet handling unit and a corresponding communication system.

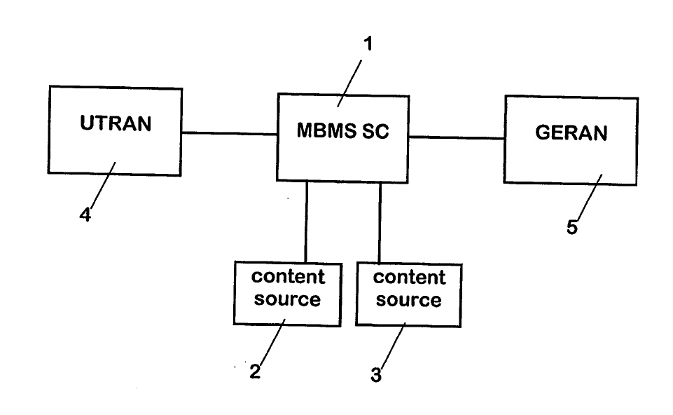

### FIELD OF THE INVENTION

The invention relates to a method for providing packet delivery and/or forwarding services via at least one public land mobile network (PLMN), wherein a packet handling unit receives from a content source content for a respective packet delivery or forwarding service that is to be transmitted on the air interface via at least two different kinds of radio access networks of the at least one PLMN. The invention equally relates to such a packet handling unit and to a communication system comprising such a packet handling unit.

### BACKGROUND OF THE INVENTION

Packet delivery and/or forwarding services can be for instance multimedia broadcast and/or multicast services, which are handled by a multimedia broadcast and multicast services service center (MBMS SC) employed as packet handling unit.

A multimedia broadcast/multicast service MBMS is to be understood as a unidirectional point to multipoint service in which multimedia data like text, audio, picture, and video is transmitted from a single source entity. A proposal for realizing such a service has been presented in a first stage of the technical specification 3GPP TS 22.146 V5.0.0 (2001-10): “Multimedia Broadcast/Multicast Service; Stage 1 (Release 5)”.

The MBMS specified in this specification comprises two modes of operation, the broadcast mode and the multicast mode.

In the broadcast mode, data of a broadcast service is transmitted to all users located in a desired broadcast area or in desired broadcast areas. The network is supposed to be responsible for defining the actual transmission of the data for the service to the respective broadcast areas.

In the multicast mode, data of a multicast service is transmitted to users belonging to a multicast group in a desired multicast area. A multicast group is a group of users that are ready to receive data which is to be transmitted as part of a multicast service. As in the broadcast mode, the network is supposed to be responsible for defining the actual transmission of the data for the service to the respective multicast areas.

Both modes are intended to enable an efficient use of radio and network resources, for example by transmitting the data over a common radio channel.

It has been proposed to provide a logical entity called MBMS service center (MBMS SC) for supporting multimedia broadcast and multicast services in a public land mobile network (PLMN). Such an MBMS SC receives the content for a multimedia service that is to be broadcast or multicast, e.g. multimedia advertisments, with a certain bandwidth from a content source for distribution to all or selected radio access networks (RAN) of the PLMN. The respective RANs then take care of the transmission of the content via the radio interface to user equipment connected to the RAN. The MBMS SC can further be employed for tasks like handling the broadcast and multicast service areas, handling a charging for specific services, taking care of security issues, considering subscription data for specific transmissions, and for providing an interface towards value added service providers (VASP).

It is possible that a single PLMN comprises radio access networks of different kinds, e.g. UTRANs (UMTS terrestrial radio access network) and GERANs (GSM Enhanced data-rates for GSM RAN). In the above mentioned technical stage 1 specification 22.146 it is even requested that the multicast areas can span more than one PLMN. However, the respective physical capacity available for a multicast or broadcast downlink can vary significantly between different radio access networks employed e.g. for WLAN (wireless local area network), Bluetooth™, GSM (global system for mobile communications), UMTS (universal mobile telecommunication services), DVB-T (digital video broadcast) and HiperLan2. UTRAN provides for example a higher bit rate and more channels and thus a higher capacity than GERAN. In addition, an operator of a PLMN might want to have the capability of restricting the capacity in some of its radio access networks or even in selected ones of its cells.

### SUMMARY OF THE INVENTION

It is an object of the invention to enable the transmission of packet delivery and/or forwarding services content. It is in particular an object of the invention to enable the transmission of content for the same packet delivery and/or forwarding service via radio access networks with different available capacities.

In order to reach these objects, a method is proposed for providing packet delivery and/or forwarding services via at least one PLMN. In this method, a packet handling unit receives from a content source content for a respective packet delivery or forwarding service that is to be transmitted on the air interface via at least two different kinds of radio access networks of said at least one PLMN. The packet handling unit then adapts the content data rate and/or the amount of data of the content separately for each radio access network via which the content is to be transmitted. Only after that, the packet handling unit forwards the content to each radio access network via which the content is to be transmitted with the respective adapted data rate and/or the respective adapted amount of data.

The objects are equally reached with a packet handling unit comprising means for realizing the proposed method. Further, the objects are reached with a communication system enabling a service provider to provide packet delivery and/or forwarding services to user equipment. The proposed system comprises at least one PLMN with at least two different kinds of radio access networks for transmitting received content for a packet delivery and/or forwarding service via the air interface to user equipment, and at least one packet handling unit with means for realizing the proposed method.

The invention proceeds from the idea that if content for a packet delivery and/or forwarding service is to be transmitted via different kinds of radio access networks with different requirements, different bit rates and/or amounts of data for a service should be determined and applied for the transmission via the different radio access networks. It is therefore proposed that the packet handling unit adapts the bit rate and the amount of data at least for each radio access network.

It is an advantage of the invention that the same content can be transmitted in different radio access networks according to the characteristics and/or the network load of the different radio access network. In particular, it can be guaranteed that each user equipment receives the respective service with the highest possible quality, while the service can be provided at the same time via radio access networks that are not able to enable a service with this high quality.

It is to be noted that the packet handling unit can be either part of the core network of a single PLMN responsible for the adaptation of data rate and/or data amount within this network, or an entity connected directly or indirectly to the radio access networks of several PLMNs. In the latter case, the packet handling unit could be a common packet handling unit responsible for the adaptation of data rate and/or data amount for the radio access networks of all connected PLMNs. Such a common packet handling unit could have access to the radio access networks of different PLMNs via additional, PLMN internal packet handling units.

Preferred embodiments of the invention become apparent from the subclaims.

The packet delivery and/or forwarding services can be in particular multicast and/or broadcast services, and more particularly multimedia multicast and/or broadcast services. In the latter case, the packet handling unit can be an MBMS SC. It is to be noted that the term MBMS SC is to be understood to comprise any unit capable of forwarding multimedia broadcast and multicast service content originating from a service provider to at least two different kinds of radio access networks, even if the term might be employed e.g. by 3GGP for units with a further detailed configuration or for a specific system like UMTS.

A packet handling unit according to the invention can be designed in particular to be able to provide content for a services for at least WLAN, Bluetooth, GSM, UMTS, DVB-T and/or HiperLan2, and to adapt the bit rate and/or the amount of data with which the content is forwarded for each system according to the capacity available in the respective system.

In a more complex, but particularly advantageous embodiment of the invention, the packet handling unit comprises means for adapting the data rate with which received content is to be transmitted and/or the amount of data which is to be transmitted according to the current traffic conditions in each individual cell of all involved radio access networks. To this end, a dynamic feedback has to be provided from the radio access networks informing the packet handling unit about the currents traffic conditions in the respective cells.

### BRIEF DESCRIPTION OF THE FIGURES

In the following, the invention is explained in more detail with reference to a drawing. The only FIGURE schematically shows an environment in which the invention can be employed.

### DETAILED DESCRIPTION OF THE INVENTION

The only FIGURE illustrates a possible arrangement of an MBMS SC in a public land mobile network, which MBMS SC was designed according to the invention.

The MBMS SC 1 is part of the core network of the PLMN and is connected to several content sources 2, 3. In addition, the MBMS SC 1 has access to an UTRAN 4 and to a GERAN 5 of a PLMN. The UTRAN 4 and the GERAN 5 both provide radio access for one or more radio cells. Even though only one UTRAN 4 and one GERAN 5 is depicted in the FIGURE, the PLMN can comprise a plurality of UTRANs and/or GERANs.

Each of the content sources 2, 3 is maintained by a service provider, which supplies the respective content source 2, 3 with content for multimedia services. A content for a multimedia service that is to be broadcast or multicast to user equipment accessing the PLMN, e.g. multimedia advertisements, audio or video streams, is uploaded from the content sources 2, 3 containing this content to the MBMS SC 1. The content is uploaded with a high bandwidth, i.e. with a high bit rate, and with the full amount of data available for the desired multimedia multicast or broadcast session.

The MBMS SC 1 is then responsible for forwarding the received content to the different radio access networks 4, 5 for a multicast or broadcast transmission to user equipment which is connected to the radio access networks 4, 5.

The physical capacity available for multicast or broadcast downlinks, however, is different for UTRAN and GERAN. Moreover, there may be several additional requirements for different access networks 4, 5 within the PLMN, or even for different cells supplied by a single radio access network 4, 5.

The MBMS SC 1 therefore comprises means for adapting the content data rate and the amount of data separately for every active downlink, i.e. for every cell, according to the respective available capacity. The bit rate can be adapted by the MBMS SC 1 for instance by selecting different codecs or different packeting schemes for the transmission. The amount of data can be adapted by the MBMS SC 1 for instance by providing video data with different resolutions.

It is to be noted that the adaptation may be carried out in common for all cells of an entire radio access network 4, 5 or for all cells assigned to a single RNC (radio network controller) of an UTRAN 4 or BSC (base station controller) of a GERAN 5, in case there are common requirements for an entire radio access network or an entire unit controlling the radio resources.

In order to take account of different influences on the available capacity, the MBMS SC 1 bases the adaptation of the bit rate and the amount of data which is forwarded on different factors. A first factor are the physical limitations in the respective radio access network 4, 5. A further factor are possible settings and/or limitations that were defined by the operator of the PLMN via an operation and maintenance (O&M) center for each radio access network 4, 5. These settings and/or limitations may be provided in general for all transmissions or specifically for multimedia broadcast/multicast services. Another factor considered by the MBMS SC 1 are possible O&M settings and/or limitations that were defined for each of the radio cell of a radio access network 4, 5 or for each of the units of a radio access network 4, 5 controlling the radio resources. Finally, also user subscription parameters are taken into account by the MBMS SC 1. For example, the maximum bit rate subscribed by one of the users located in a specific cell can form the basis for limiting the bit rate employed for a transmission in this cell.

1. Method for providing packet delivery and/or forwarding services via at least one public land mobile network (PLMN), wherein said packet delivery and/or forwarding services are multimedia broadcast and/or multicast services, wherein a packet handling unit receives from a content source content for a respective packet delivery or forwarding service that is to be transmitted on the air interface via at least two different kinds of radio access networks of said at least one PLMN, wherein said packet handling unit adapts the content data rate and/or the amount of data of said content separately for each radio access network via which said content is to be transmitted, and wherein said packet handling unit forwards said content to each radio access network via which said content is to be transmitted with the respective adapted data rate and/or the respective adapted amount of data.

2. Method according to claim 1, wherein said packet handling unit adapts said data rate and/or said amount of data for each radio access network via which said content is to be transmitted based on the physical limitations of each of said radio access networks.

3. Method according to claim 1, wherein said packet handling unit adapts said data rate and/or said amount of data for each radio access network via which said content is to be transmitted based on settings and limitations defined by an operator of said at least one PLMN for the respective radio access network.

4. Method according to claim 1, wherein said packet handling unit adapts said data rate and/or said amount of data for each network element controlling the radio resources for at least one radio cell of at least one of said radio access networks via which said content is to be transmitted based on settings and limitations defined by an operator for said network element.

5. Method according to claim 1, wherein said packet handling unit adapts said data rate and/or said amount of data for at least one radio cell of at least one of said radio access networks via which said content is to be transmitted based on settings and limitations defined by an operator for said radio cell.

6. Method according to claim 1, wherein said packet handling unit adapts said data rate and/or said amount of data for at least one radio cell of at least one of said radio access networks via which said content is to be transmitted based on subscription parameters of user equipment connected to said radio cell.

7. Method according to claim 1, wherein said packet handling unit adapts said data rate and/or said amount of data for at least one radio cell of at least one of said radio access networks via which said content is to be transmitted based on the current traffic conditions in said radio cell.

8. (Cancelled).

9. Method according to claim 1, wherein said packet handling unit is a multimedia broadcast and multicast services service center (MBMS SC).

10. Packet handling unit comprising means for realizing the method according to claim 1.

11. Packet handling unit according to claim 9, wherein said packet handling unit is a multimedia multicast and broadcast services service center (MBMS SC).

12. Communication system enabling a service provider to provide packet delivery and/or forwarding services to user equipment, comprising at least one public land mobile network (PLMN) with at least two different kinds of radio access networks for transmitting received content for a packet delivery or forwarding service via the air interface to said user equipment, and comprising at least one packet handling unit with means for realizing the method according to claim 1.

13. Communication system according to claim 11, wherein said packet handling unit is a multimedia multicast and broadcast services service center (MBMS SC).
